(19) United States
(12) Patent Application Publication
(10) Pub. No.: US 2023/0145912 A1
(43) Pub. Date: May 11, 2023

(54) Wire electrode for spark-erosion cutting

(71) Applicant: Berkenhoff GmbH, Heuchelheim (DE)

(72) Inventors: Bernd BARTHEL, Steffenberg (DE); Stefan FLÜGGE, Hemer (DE); Tobias NÖTHE, Herborn (DE); Ivo Zunke, Gießen (DE)

(21) Appl. No.: 17/906,948

(22) PCT Filed: Mar. 30, 2021
(86) PCT No.: PCT/EP2021/058275

§ 371 Date: Sep. 21, 2022

(30) Foreign Application Priority Data
Mar. 31, 2020 (EP) 20167319.1

(51) Int. Cl. B23H 7/08; B23H 7/24

(52) U.S. Cl. CPC B23H 7/08; B23H 7/24

(57) ABSTRACT

The present invention relates to a wire electrode for spark-erosion cutting having a core (2), which contains a metal or a metal alloy, and a covering layer (3), surrounding the core (2), which comprises regions the morphology of which corresponds to block-like particles, which are spatially separated, at least over a portion of their circumference, from each other and/or the core material by cracks, characterized in that, viewed in a wire cross section perpendicular or parallel to the wire longitudinal axis, the portion amounting to more than 50% of the surface area of a region with the morphology of a block-like particle contains a copper-zinc alloy with a zinc concentration of 58.5-67 wt.-%, wherein, in a view perpendicular to the wire surface, the proportion of the surface formed by the block-like particles is more than 20% and less than 50% of the entire surface of the wire electrode and the block-like particles the surface area of which in each case lies in the range of 25-250 μm² in total make up a proportion of more than 50% of the surface area of all block-like particles.

### FIELD OF THE INVENTION

The present invention relates to a wire electrode for spark-erosion cutting and a method for the production thereof.

### STATE OF THE ART

Spark-erosion methods (Electrical Discharge Machining, EDM) are used for separating electrically conductive workpieces and are based on the removal of material by means of spark discharges between the workpiece and a tool. For this purpose, in a dielectric liquid such as, for example, deionized water or oil, controlled spark discharges are produced between the respective workpiece and the tool, which is arranged at a short distance therefrom and which acts as an electrode, through the application of voltage pulses. In this manner, workpieces which consist, for example, of metals, electrically conductive ceramics or composite materials etc. can be machined substantially irrespective of their hardness. The electrical energy for the spark discharges is provided by the pulse generator of the eroding machine.

A special spark-erosion method, in which the tool is constituted by a tensioned, thin wire having typical diameters in a range of from approximately 0.02 to 0.4 mm, is spark-erosion cutting or wire erosion. As the wire wears during the eroding process as a result of the removal of material, it has to be continuously drawn through the cutting or machining zone and can only be used once, i.e. the wire is consumed continuously. The desired cutting contour is carried out through a so-called main cut with relatively high discharge energy first. To improve the contour precision and the surface roughness of the workpiece, the main cut can be followed by one or more so-called trim cuts with successively reduced discharge energy. During these trim cuts the wire electrode is engaged only with a portion of its circumference. The setting parameters on the machine side for the main cut and the trim cuts, such as open-circuit voltage, pulse current, pulse duration, pause duration, gap-width regulation parameters, wire pre-tensioning force, wire run-off speed, flushing pressure etc., are combined in so-called technologies or eroding or cutting technologies. For different material types to be machined, workpiece heights, wire types, wire diameters and quality targets, corresponding eroding technologies are available on eroding machines customary in the trade.

In practice, use is made of both coated and uncoated wires or wire electrodes, which nowadays are usually produced on the basis of brass or copper. Uncoated wire electrodes, which are also referred to as bare wires, consist of a homogeneous material, whereas coated wire electrodes have a covered or coated core. In the state of the art, coated wire electrodes are normally constructed such that a jacket or covering, which can be composed of one covering layer or several covering layers arranged one on top of another, is responsible for the actual erosion process, whereas the core of the wire electrode, for example, imparts the tensile strength, necessary for the through-passage of the wire and for the wire pre-tensioning, and the necessary electrical and thermal conductivity.

Bare wires typically consist of brass with a zinc proportion of between 35 and 40 wt.-%, whereas most coated wires have a core of copper or brass and one or more covering layers of zinc or a copper-zinc alloy. As materials involved in the actual eroding process, zinc and brass, owing to the presence of zinc, with its low vaporization temperature, offer the advantages of a relatively high removal rate and efficiency of the eroding process and the possibility of the transfer of very small pulse energies for the fine finishing of workpiece surfaces, i.e. machining generating surface roughnesses as small as possible. Against this background, for the purpose of fine finishing, wire electrodes which have a covering layer which consists predominantly or exclusively of zinc are often used.

It is known that, compared with bare wires and wires which have over a coating which consists predominantly or exclusively of zinc, the removal rate or cutting performance can be increased by using wires which are provided with a coating which contains one or more zinc-containing alloys. These include wires the coating of which contains brass in one or more of the phases β or β′, respectively, γ and ε.

To achieve high cutting performances, it has proved to be advantageous to produce a coating from a brittle alloy, such as e.g. brass in the γ phase, in a diameter that is larger than the final diameter by diffusion, and then to draw it to the final dimension by cold forming. As a result, the brittle-hard layer breaks open, with the result that indentations and continuous cracks form in it and the material located underneath comes through (cf. U.S. Pat. Nos. 5,945,010, 6,306,523). The cracks and indentations increase the surface area of the wire. The latter is thereby better cooled by the surrounding dielectric, and the removal of removed particles from the gap is also promoted. Aside from that, discharges preferably form at the edges produced by the cracks due to the excessive increase of the electrical field. This promotes the ignitability of the wire electrode, and thus the cutting performance. According to U.S. Pat. No. 5,945,010, good eroding results in the sense of cutting performance and surface quality are achieved if the coating covers less than 100% and more than 50% of the wire surface.

This and further developments for increasing the cutting performance are also based on combinations of different ones of the named covering layers, optionally with further layers, in a covering constructed multi-layered. Occasionally, sometimes compulsorily owing to diffusion processes which take place during the corresponding production processes, jackets which have a brass covering layer with a phase mixture of for example α and β phase or of β and γ phase have also been proposed here.

In U.S. Pat. No. 7,723,635 a wire electrode is proposed which has a core and a first covering layer of a brass alloy with approx. 37-49.5 wt.-% zinc, wherein uniformly distributed so-called grains, which are spaced apart from each other and which contain a brass alloy with a zinc proportion of approx. 49.5-58 wt.-% zinc, are present embedded in the covering layer. With such a wire electrode, the eroding properties are to be enhanced on the basis of improved electrical conductivity and strength.

According to EP-A-2 193 867 at least one of several covering layers has predominantly a fine-grained mixture of β and γ brass. Through the incorporation of the γ brass in a matrix of β brass, the γ brass will not wear too quickly during the eroding process, but will be released into the eroding gap in small doses in an effective manner in terms of removal.

In EP-A-1 846 189 a wire electrode is proposed which contains a first layer of β brass as well as a torn layer of γ brass, in the holes of which the layer of β brass emerges.

EP-A-2 517 817 describes a wire electrode with two alloy layers formed by diffusion. The core wire material emerges along cracks in the second alloy layer, with the result that a plurality of grain-like structures are formed on the surface. Grains which contain the core material, and, are arranged in a direction substantially perpendicular to a longitudinal direction of the wire electrode. Both the cutting performance and the surface quality are hereby improved.

However, in connection with coatings of brittle phases like the γ phase, it has been shown that, on the one hand, an increase in the layer thickness does not necessarily lead to a further increase in performance (cf. EP-A-1 295 664) and, on the other hand, limits are set on the formability of thicker layers with regard to economic producibility (cf. U.S. Pat. No. 5,945,010).

A substantial disadvantage of the above-named wire electrodes is that, on eroding machines which do not have eroding technologies matched specifically to these wire electrodes by the manufacturer but only have standard technologies for bare brass wires, they often do not achieve the precision and/or surface quality required for the component to be machined. Although remedial measures here can create an adaptation or optimization of the eroding technologies present, businesses in the erosion industry usually cannot or do not wish to accept the expenditure of time necessary for this.

In particular in the case of a multi-step eroding machining with one or more fine-finishing steps to achieve a smaller surface roughness, it is known e.g. that the formation of undesired grooves with a course parallel to the wire run-off speed occurs with wire electrodes according to U.S. Pat. No. 5,945,010 (see the comparison tests in EP-A-1 949 995). In EP-A-1 949 995, therefore, to remedy this, a wire electrode with a covering layer formed by block-like structures (“blocks”) is proposed, wherein the blocks have a very uniform thickness, have a zinc proportion of more than 50 wt.-%, and cover the wire surface to an extent of more than 50%. In addition, cracks which result between the blocks follow a preferred orientation which forms an angle with the wire longitudinal axis of more than 45%. These features are achieved by the approximate thickness of the covering layer before the final drawing process being 7 μm or less and the ratio of final diameter and intermediate diameter before the final drawing process lying in the range of from 0.4 to 0.8. However, this requires either that the wire electrode is zinc-coated in a correspondingly small diameter or that another intermediate drawing has to be carried out after the zinc-coating in a larger diameter. Both impair the economic viability of the production of the wire electrode.

### Object of the Invention

An object of the invention is to provide a wire electrode with which on the one hand a higher cutting performance, and thus improved economic viability of the wire-eroding technique, compared with bare brass wires and on the other hand an equal or higher precision and surface quality on the component compared with bare brass wires and the above-named coated wires are achieved.

Furthermore, an object of the invention is to provide a wire electrode which can be operated with eroding technologies for bare brass wire, in particular for those eroding technologies which comprise several cuts, with the result that a higher cutting performance compared with bare brass wires is achieved, and an equal or higher precision and surface quality on the component compared with bare brass wires and the above-named coated wires is achieved.

A further object of the invention is to provide a wire electrode with the above-named advantages which can be produced with as little manufacturing effort as possible.

### SUMMARY OF THE INVENTION

To achieve this object, a wire electrode with the features of claim 1 is used. Advantageous embodiments of the wire electrode are the subject of the respective dependent claims.

### BRIEF DESCRIPTION OF THE FIGURES

FIG. 1 shows, schematically and not to scale, a cross section (perpendicular to the longitudinal axis) of a first embodiment of the wire electrode according to the invention.

FIG. 2 shows an optical microscopy picture of a cutout of the outer circumference of a wire electrode according to the invention in a cross section perpendicular to the longitudinal axis of the wire.

FIG. 3 shows a cutout of the outer circumference of the wire electrode according to the invention according to FIG. 1 in a cross section perpendicular to the longitudinal axis.

FIG. 4 shows an optical microscopy picture of the surface of a wire electrode according to the invention.

FIG. 5 shows the optical microscopy picture from FIG. 3 with a rectangular reference frame for determining the degree of coverage with block-like particles or clusters formed thereof.

FIG. 6 shows the optical microscopy picture from FIG. 3 with the wire longitudinal axis and the line-shaped clusters of block-like particles marked.

FIG. 7 shows the optical microscopy picture of the surface of a first wire electrode not according to the invention.

FIG. 8 shows the optical microscopy picture of the surface of a second wire electrode not according to the invention.

### DETAILED DESCRIPTION OF THE INVENTION

According to the present invention, it is provided that a wire electrode for spark-erosion cutting has a core which contains a metal or a metal alloy. It is preferred that the core consists of one or more metals and/or one or more metal alloys to an extent of more than 50 wt.-% and more preferably completely or substantially completely. In particular, the core can therefore be formed altogether of one metal or of one metal alloy. The core can be formed homogeneous or, for example in the form of several individual metal or metal alloy layers of different composition arranged one on top of another, have properties that vary in the radial direction. As used herein, “substantially” means that the wire according to the invention or a layer thereof, or its core, consists of the respectively disclosed composition and/or has the disclosed properties, wherein production and measurement tolerances are to be taken into account, e.g. the presence of unavoidable impurities, which are familiar to experts.

The metal is in particular copper and the metal alloy is in particular a copper-zinc alloy with a zinc proportion of 20-42 wt.-%.

Surrounding the core, for example in the form of a coating, a jacket (also called “covering layer” in the following) is provided. The covering layer wears during a wire-eroding process and is provided to influence the eroding properties.

The covering layer of the wire electrode according to the invention comprises regions which have a particulate appearance (morphology), which are characterized in particular by an irregular contour, which contain sometimes sharp corners with a corner radius of less than 2 μm and lines with a straightness which deviate by less than 2 μm from an ideal straight line. These regions are therefore described as regions the morphology of which corresponds to block-like or block-shaped particles. In the following, the layer containing these regions is also called “covering layer with block-like morphology” and the regions the morphology of which corresponds to block-like or block-shaped particles are also called “block-like particles” (or “block-shaped particles”) for short. The core material can come through between the block-like particles. The block-like particles are additionally spatially separated, at least over a portion of their circumference, from each other and/or from the core material by cracks. The block-like particles themselves can contain cracks.

The cracks generally have a width of up to approximately 2 μm, predominantly approximately 1 μm, as can be determined by means of scanning electron microscopy under usual conditions, e.g. by analysis of an image measured on the basis of backscattered electrons (20 kV). If a larger crack width appears along the course of a crack over a short distance (e.g. 1 to 2 μm), this structure is likewise regarded as a crack within the meaning of the present invention. In comparison, wider spacings between the block-like particles (which usually form radially inwards from the outer surface of the wire) are called indentations or gaps.

Viewed in a wire cross section, perpendicular or parallel to the longitudinal axis of the wire (also called “wire longitudinal axis” or, for short, only “wire axis” herein), the predominant portion, i.e. amounting to more than 50%, of the surface area of the block-like particles contains a copper-zinc alloy with a zinc concentration of 58.5-67 wt.-%. According to the phase diagram for the CuZn system, the alloy is present in this portion of the surface area as γ phase. At the boundary to adjacent material of the wire, a “seam” of β and/or β′ phase can form (if copper or α brass is used as core material). This seam is normally recognizable using optical microscopy (or can be determined using other methods known to experts, such as SEM/EDX, as explained in more detail below) and is not attributed to the block-like particles.

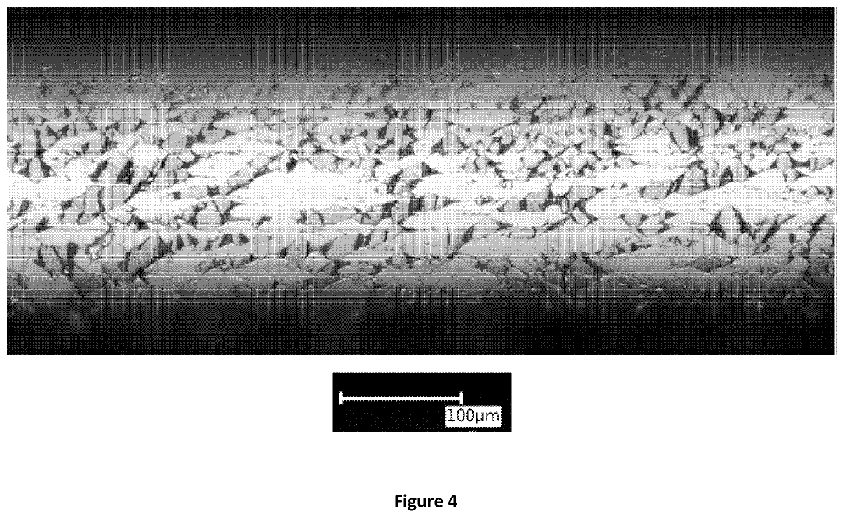

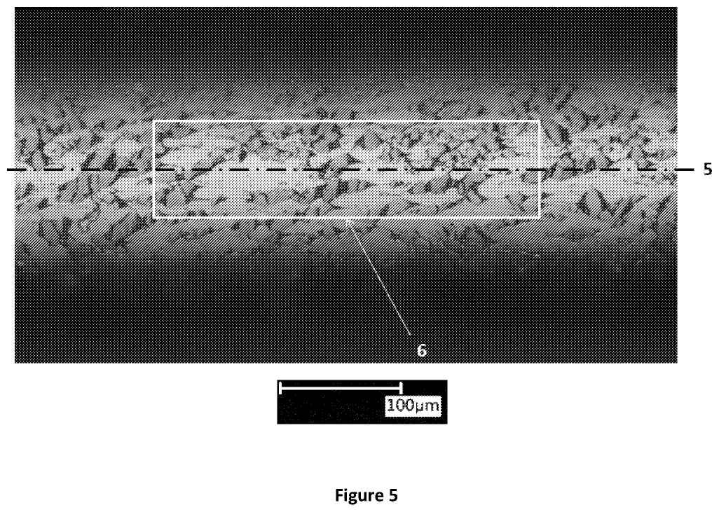

The surface of the wire electrode is formed by the block-like particles, by the core material and optionally by the “seam” of β and/or β′ phase. In a view perpendicular to the wire surface, as is shown in FIGS. 4 to 6 (perpendicular with respect to the point of the wire circumference lying closest to the observer (microscope) seen radially), the proportion of the surface formed by the block-like particles, i.e. the degree of coverage, is more than 20% and less than 50% of the entire surface of the wire electrode. The determination of these values can be effected as described with respect to FIG. 5 and as represented in the figure itself by means of a suitable reference surface area. This reference surface area is defined in FIG. 5 by means of the light reference frame 6, which has a size of approximately 400 μm×50 μm and is arranged symmetrical with respect to the wire longitudinal axis.

In the above view perpendicular to the wire surface, the block-like particles the surface area of which lies in the range of 25-250 μm² yield a total proportion of more than 50% of the surface area of all block-like particles.

In the above view perpendicular to the wire surface, the block-like particles are arranged, in a significant proportion and in particular predominantly, in line-shaped clusters of four or more particles. In these clusters the spacing between the particles is less than 15 μm. Particles arranged next to each other which meet this spacing criterion are also called adjacent particles.

By line-shaped is meant that the particles are arranged next to each other in a “row” as uniform structure features, wherein the arrangement can have a certain irregularity (with respect to size and spatial arrangement of the particles). However, it is characteristic that the line-shaped clusters have a preferred direction, namely through the arrangement in a row (=line), which defines a longitudinal direction, and that in the direction transverse thereto, along the line, there are no or only a few directly adjacent particles, i.e. particles which have a spacing of less than 15 μm, as defined above.

In particular, there are only a few arrangements of block-like particles which lie next to each other in the form of a jumbled “pile”, or strip-like arrangements which are formed of several line-shaped clusters which are arranged directly next to each other over a substantial portion of their extent in the longitudinal direction, i.e. so close that the particles have a spacing in the (perpendicular) transverse direction of less than 15 μm.

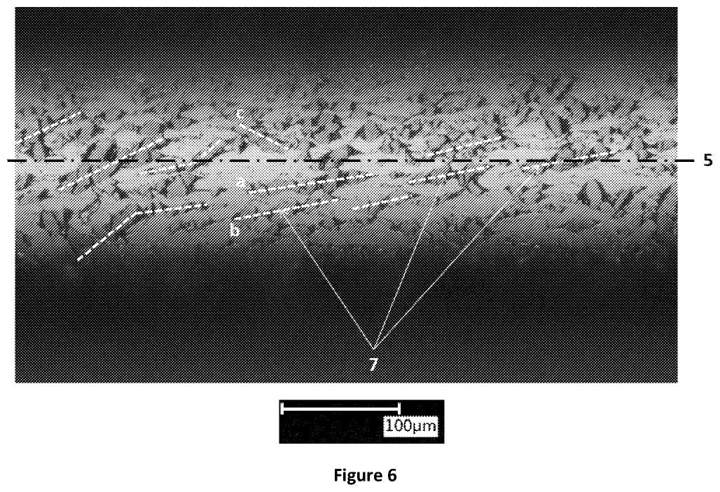

The clusters thereby have a “scattered” appearance, i.e. the clusters have only a few “points of contact” with other clusters, as is the case for example in the clusters (a) and (b) shown in FIG. 6.

This characteristic morphological appearance of the clusters can be quantified as follows.

An arrangement of block-like particles which, as disclosed above, have a surface area in the range of 25-250 μm² is selected which contains so many particles of this size that they can be connected with a straight line (longitudinal axis), wherein the longitudinal axis has to intersect or touch all particles of the cluster which meet the above size criterion, and adjacent particles (of this size) have a spacing in this longitudinal direction defined in this way of less than 15 μm, or can be separated by very small particles, without the spacing criterion of less than 15 μm being violated.

As the starting and end points of the longitudinal axis, the ends, lying furthest apart from each other, of the particles, lying furthest from each other, of the cluster determined according to the above criteria are chosen.

The predominant portion, i.e. more than 50%, of the line-shaped clusters form an angle with the longitudinal axis of the wire electrode of less than 45°, independently of the direction of view along the longitudinal axis of the wire electrode, see for example the clusters (a) and (c) in FIG. 6.

As disclosed above, the clusters occur in a scattered manner, i.e. several line-shaped clusters do not normally lie immediately next to each other (i.e. with a spacing in the transverse direction, thus perpendicular to the above-defined longitudinal direction of the clusters, which is smaller than 15 μm). This can also be seen by way of example in the arrangement of the clusters (a) and (b) in FIG. 6.

Viewed in a wire cross section perpendicular or parallel to the wire longitudinal axis, more than two thirds of the block-like particles have a thickness, measured in the radial direction, of more than 0.8% and less than 2% of the total diameter of the wire electrode.

The metals contained in the core and the coating can have unavoidable impurities.

According to the state of the art, it was to have been expected that a wire electrode with a broken-open layer which contains block-like particles which have a zinc content of more than 50 wt.-%, but which has a degree of coverage with such particles of less than 50%, and does not have a preferred orientation of the cracks substantially perpendicular to the wire longitudinal axis, is neither particularly advantageous for the cutting performance nor particularly advantageous for the surface quality of the component.

However, it has proved that with the wire electrode according to the invention, in particular in the case of the use of eroding technologies for bare brass wires, very good results with respect to cutting performance and surface quality can be achieved. Without being bound to a specific theory, it is assumed that the following features or the combination thereof contribute to a very uniform feed in the individual cuts of the spark-erosion machining:
the presence of a degree of coverage of less than 50% and more than 20%,
the fact that the block-like particles the surface area of which lies in the range of 25-250 μm² yield a total proportion of more than 50% of the surface area of all block-like particles, and
furthermore the arrangement of the block-like particles in line-shaped clusters of at least 4 particles, in a significant quantity or predominantly.

In addition, a significant reduction in the machining time results compared with bare brass wires both in the main cut and in the entire machining sequence.

Furthermore, because of the thickness, set in a targeted manner, of the block-like particles of more than 0.8% and less than 2% of the total diameter of the wire electrode in the case of at least two thirds of the block-like particles, in combination with the above-named features, very good surface qualities with very little formation of grooves with a course parallel to the wire run-off speed can be achieved.

### Production

The production of the wire electrode according to the invention is effected starting from an initial material which consists of one or more metals and/or one or more metal alloys to an extent of more than 50 wt.-% and more preferably completely or substantially completely. Thus, for example, it is possible to proceed from an initial material in the form of a homogeneous wire of Cu, CuZn₃₇ or CuZn₄₀ (brass with 37 or 40 wt.-% zinc respectively) with a diameter of e.g. 1.20 mm. Starting from this initial material, the production of the wire electrode according to the invention ideally comprises only the three process steps of coating with zinc, diffusion annealing and drawing with final, integrated stress-relief annealing. The diameter of the initial material before the diffusion annealing is chosen such that during the drawing to the final diameter a reduction in the cross-sectional surface area by a factor of 20-25 is achieved. In a first step, the initial material is coated with zinc, for example by electrodeposition. The thickness of the zinc layer, which is to be present at the diameter before the diffusion annealing, is determined by the zinc content of the chosen core material. If, e.g., a homogeneous core which consists of the alloy CuZn₃₇ is chosen, the thickness of the zinc layer preferably lies in a range of from 0.8 to 1.6% of the desired final diameter. If, e.g., a homogeneous core which consists of the alloy CuZn₄₀ is chosen, the thickness of the zinc layer preferably lies in a range of from 0.6 to 1.4% of the desired final diameter.

The wire coated with zinc is then subjected to a diffusion annealing, in which a covering layer is produced which contains predominantly a copper-zinc alloy with a zinc concentration of 58.5-67 wt.-%. According to the phase diagram for the CuZn system, this alloy is present as γ phase.

The diffusion annealing can be carried out both in a stationary manner, e.g. in a hood-type furnace, and in a continuous process, e.g. by resistance heating. The diffusion annealing can be carried out e.g. in a hood-type furnace under ambient atmosphere or protective gas, preferably in a range of 180-230° C., for 4-12 h, wherein the average heating rate is preferably at least 80° C./h and the average cooling rate is preferably at least 60° C./h. It can alternatively be effected e.g. by resistance heating in a continuous pass under ambient atmosphere or protective gas, wherein the average heating rate is preferably at least 10° C./s, the max. wire temperature preferably lies between 600 and 800° C., the annealing time preferably lies in the range of 10-200 s and the average cooling rate is preferably at least 10° C./s. The above annealing times relate to the period of time from when room temperature is departed from to when room temperature is reached again.

In the last step, the wire is preferably tapered to the final diameter by cold forming and stress-relief annealed. The final diameter lies in the range of 0.02-0.40 mm. Here, the brittle-hard layer of brass in γ phase tears, with the result that block-like particles form. The block-like particles are spatially separated from each other, with the result that the core material can emerge between the block-like particles. The block-like particles themselves can contain cracks.

Due to the thickness, chosen in a targeted manner as described above, of the zinc layer before the diffusion annealing and the cross-section reduction, chosen in a targeted manner, during the drawing to the final diameter, block-like particles are produced which have in each case a surface area in the range of 25-250 μm² in a view perpendicular to the wire surface, and which yield a total proportion of more than 50% of the surface area of all block-like particles, and which, in a view perpendicular to the wire surface, are furthermore arranged, in a significant quantity and in particular predominantly, in line-shaped clusters of at least four particles. In these clusters the spacing between the particles is less than 15 μm. The predominant portion, i.e. more than 50%, of the line-shaped clusters form an angle with the longitudinal axis of the wire electrode of less than 45°. The degree of coverage by the block-like particles is less than 50% and more than 20% of the entire surface of the wire electrode. Furthermore, reference is made to the above disclosure regarding the further details of the clusters.

The formation of the line-shaped clusters is promoted in addition by a cross-section reduction per drawing step which lies in a range of about 8-12%, at least in the last 12 drawing steps.

If the thickness in the case of more than two thirds of the block-like particles in the case of the final diameter lies below 0.8% of the final diameter of the wire electrode and the block-like particles, which in each case have a surface area in the range of 25-250 μm², in total make up less than 50% of the surface area of all block-like particles, no substantial increase in the cutting performance compared with bare brass wire is achieved with such an embodiment.

If, on the other hand, the thickness of the coating after the diffusion annealing is too large, block-like particles with a thickness of more than 2% of the final diameter and a surface area, viewed in a view perpendicular to the wire surface, of more than 250 μm² increasingly form after the drawing to the final diameter. In addition, the thickness of the block-like particles varies more strongly, as the brittle-hard layer of brass in γ phase is fragmented more strongly in the radial direction as a result of the cold forming. With such an embodiment, although a substantial increase in the cutting performance compared with bare brass wire is achieved in the main cut, such an embodiment increasingly leads to short circuits and accidental discharges in the trim cuts. Not only does this result in a decrease in the cutting performance, it also impairs the surface quality of the component.

Alternatively, the coating can first be followed by an intermediate drawing, before the wire is subjected to the diffusion annealing. This can be, e.g., an economic alternative for producing wire electrodes according to the invention in the diameter range of 0.02-0.15 mm.

Overall, the wire electrode according to the invention can be produced with little manufacturing effort. If, in particular for the core material, a copper-zinc alloy with 37-40 wt.-% zinc is chosen, the necessary thickness of the zinc layer is only 0.6-1.6% of the final diameter. In the case of a final diameter of e.g. 0.25 mm the necessary thickness of the zinc layer is 1.5-4 μm. This allows a relatively high throughput speed during the zinc coating. Moreover, the above-named range for the necessary zinc layer thickness allows relatively short treatment times during the diffusion annealing. Finally, the degree of coverage of more than 20% and less than 50% reduces the wear on drawing tools compared with wire electrodes according to the state of the art.

### Preferred Embodiments

Viewed in a wire cross section, perpendicular or parallel to the longitudinal axis of the wire (also called “wire longitudinal axis” or, for short, only “wire axis” herein), the portion amounting to more than 75%, and more preferably the portion amounting to more than 90%, of the surface area of the block-like particles preferably contains a copper-zinc alloy with a zinc concentration of 58.5-67 wt.-%. Still more preferably, the block-like particles consist substantially completely of a copper-zinc alloy with a zinc concentration of 58.5-67 wt.-%. In relation to the formation of a “seam” of a copper-zinc alloy with a lower zinc concentration at the boundary to adjacent wire material, reference is made to the above disclosure.

In a view perpendicular to the wire surface, as defined above, the proportion of the surface formed by the block-like particles, i.e. the degree of coverage, is preferably more than 30% and less than 45% of the entire surface of the wire electrode.

Preferably, in the view perpendicular to the wire surface, the block-like particles the surface area of which lies in the range of 25-200 μm² yield a total proportion of more than 50% of the surface area of all block-like particles.

More preferably, in the view perpendicular to the wire surface, the block-like particles the surface area of which lies in the range of 50-200 μm² yield a total proportion of more than 50% of the surface area of all block-like particles.

The block-like particles are arranged, in a significant quantity and in particular predominantly, in line-shaped clusters of preferably five or more particles. In the line-shaped clusters the spacing between the block-shaped particles is preferably less than 10 μm.

As disclosed above, although the clusters occur in a significant quantity and in particular predominantly, they remain “scattered”, i.e. several line-shaped clusters do not normally lie immediately next to each other (i.e. with a spacing in the transverse direction, thus perpendicular to the above-defined longitudinal direction of the clusters, which is less than 15 μm, preferably less than 10 μm). This is shown by way of example in the arrangement of the clusters (a) and (b) in FIG. 6. A line-shaped cluster preferably contains particles of an adjacent cluster over less than 50% of its length, as defined above.

The predominant portion, i.e. more than 50%, of the line-shaped clusters preferably form an angle with the longitudinal axis of the wire electrode of less than 40° and more preferably of less than 35°. Preferably, more than 75% of the line-shaped clusters form an angle with the longitudinal axis of the wire electrode of less than 45°.

Viewed in a wire cross section perpendicular or parallel to the wire longitudinal axis, preferably more than 75% and more preferably more than 90% of the block-like particles have a thickness, measured in the radial direction, of more than 0.8% and less than 2% of the total diameter of the wire electrode.

The wire electrode according to the invention has a wire core which preferably consists of the alloy CuZn₃₇ or CuZn₄₀.

The structure and the composition of the wire electrode according to the invention can be determined e.g. by means of a scanning electron microscopy (SEM) investigation with energy-dispersive X-ray spectroscopy (EDX). For this, the surface and a cross-section polish of the wire electrode are investigated. The production of a wire cross-section polish can be effected e.g. by the so-called ion beam slope cutting method, in which the wire is covered by a screen and irradiated with Ar⁺ ions, wherein material is removed from portions of the wire protruding beyond the screen by the ions. Through this method, samples can be prepared free of mechanical deformations. The structure of the covering layer of the wire electrode according to the invention is thus retained through such a preparation. The structure of the covering layer of the wire electrode according to the invention can thus be represented by the SEM images. By means of point, line and surface EDX analyses, the composition of the wire electrode according to the invention can be determined.

The invention is explained in more detail in the following with reference to the drawings.

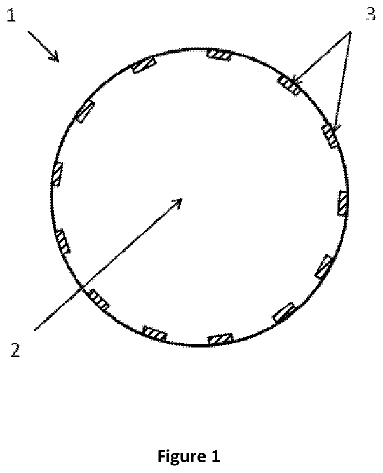

The wire electrode 1 shown in cross section in FIG. 1 has a wire core 2, which is surrounded by a covering. In the example embodiment represented, the core 2 is homogeneously completely or substantially completely formed of copper or a copper-zinc alloy with a zinc content of preferably from 20 to 40 wt.-%. The covering layer is formed by block-like particles 3 which are spatially separated from each other or from the material 2 of the core (e.g. by cracks (not shown)).

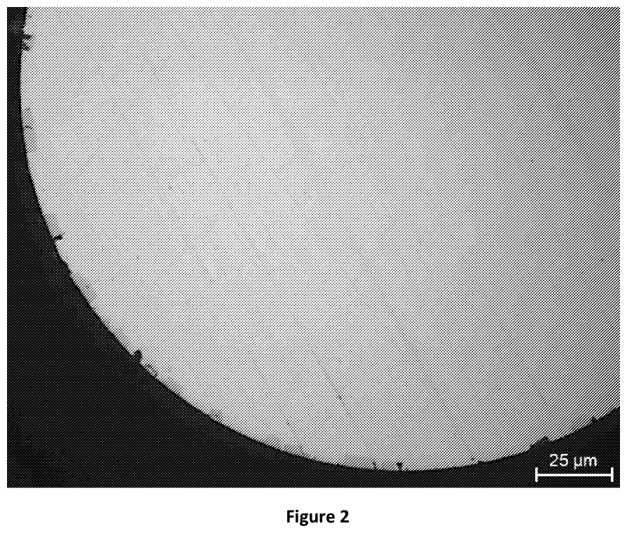

FIG. 2 shows, in a cross section perpendicular to the longitudinal axis, an optical microscopy picture of a cutout of the outer circumference of the wire electrode according to the invention according to FIG. 1 with the wire core and the block-shaped particles. The more precise shape of the block-like or block-shaped particles (dark grey regions) and the fact that they are separated, over a portion of their circumference or over their entire circumference (viewed in this cross section), from each other or from the adjoining material of the core (light grey regions) by cracks (black regions) are recognizable.

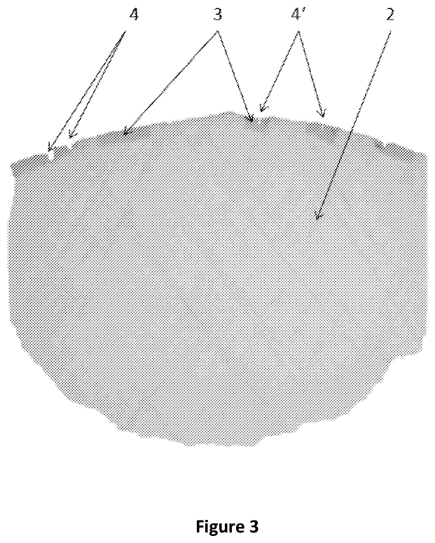

FIG. 3 shows, in a cross section perpendicular to the longitudinal axis, a cutout of the outer circumference of the wire electrode according to the invention according to FIG. 1 with the wire core 2 and the block-shaped particles 3. The fact that the block-shaped particles are separated, over a portion of their circumference (viewed in this cross section), from each other or from the adjoining material of the core (light grey regions) by cracks and indentations or gaps 4 is recognizable. Furthermore, cracks 4′ which the block-like particles themselves contain are recognizable.

FIG. 4 shows an optical microscopy picture of the surface of a wire electrode according to the invention with a magnification of 500. The block-like particles (dark grey regions) of the covering layer as well as cracks and indentations or gaps (black regions) are recognizable.

FIG. 5 shows the optical microscopy picture of the surface of a wire electrode according to the invention according to FIG. 4. To determine the degree of coverage, a rectangular reference frame 6 with the dimensions 400×50 μm is drawn in here symmetrically to the centre axis 5 of the wire electrode. The degree of coverage can be determined e.g. by means of an image processing program by calculating the surface formed by the block-like particles on the basis of their specific colouring within the reference frame and setting it in relationship to the surface area of the reference frame. The surface area of the individual block-like particles within the reference frame can likewise be calculated e.g. by means of an image processing program.

FIG. 6 likewise shows the optical microscopy picture of the surface of a wire electrode according to the invention according to FIG. 4. The line-shaped clusters 7 of four or more block-like particles are marked with the aid of the additionally drawn-in dashed lines. With the aid of the likewise represented centre axis 5 of the wire electrode, it becomes clear that the line-shaped clusters form an angle with the longitudinal axis of the wire electrode of less than 45°.

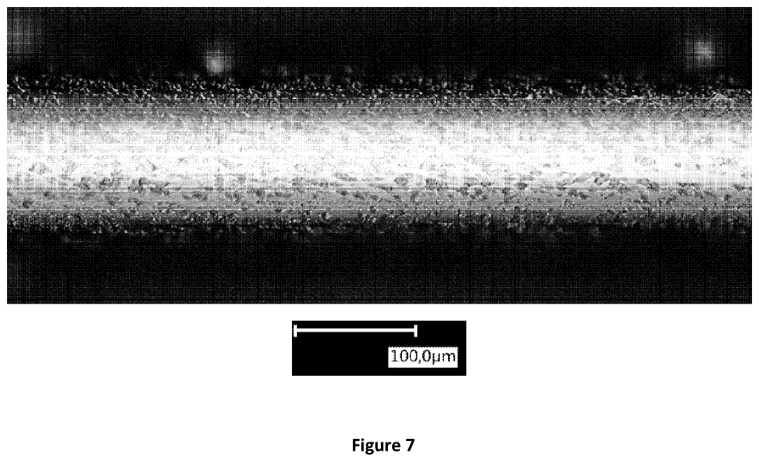

FIG. 7 shows the optical microscopy picture of the surface, with a magnification of 500, of a wire electrode not according to the invention according to comparison sample V2.

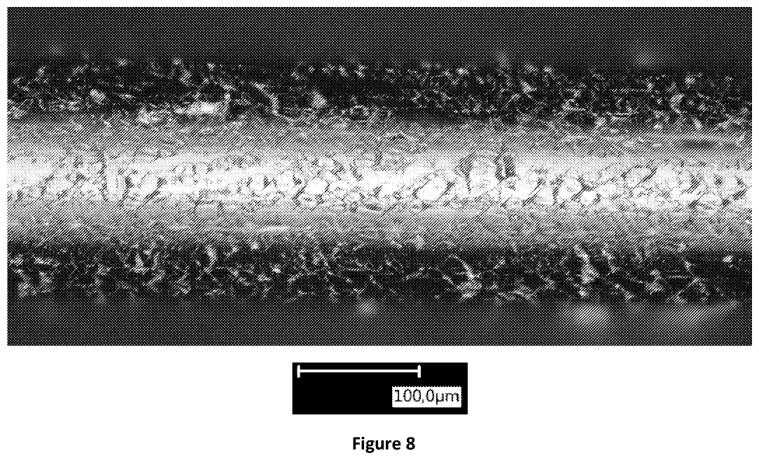

FIG. 8 shows the optical microscopy picture of the surface, with a magnification of 500, of a wire electrode not according to the invention according to comparison sample V3.

### EXAMPLES

The advantages of the wire electrode according to the invention are explained in the following with reference to two embodiment examples in comparison with different wire electrodes according to the state of the art. The production of the wire samples was effected according to the sequences represented in the following:

Comparison sample V1:
Initial wire: CuZn40, d=1.20 mm
Drawing to d=0.25 mm and stress-relief annealing

Comparison sample V2:
Initial wire: CuZn37, d=1.20 mm
Electrodeposition of zinc with 1.5 μm
Diffusion annealing in a hood-type furnace under ambient atmosphere at 180° C., 9 h
Drawing to d=0.25 mm and stress-relief annealing

Comparison sample V3:
Initial wire: CuZn40, d=1.20 mm
Electrodeposition of zinc with 7 μm
Diffusion annealing in a hood-type furnace under ambient atmosphere at 180° C., 9 h
Drawing to d=0.25 mm and stress-relief annealing

Sample E1 according to the invention:
Initial wire: CuZn37, d=1.20 mm
Electrodeposition of zinc with 3 μm
Diffusion annealing in a hood-type furnace under ambient atmosphere at 180° C., 9 h
Drawing to d=0.25 mm and stress-relief annealing

Sample E2 according to the invention:
Initial wire: CuZn40, d=1.20 mm
Electrodeposition of zinc with 2 μm
Diffusion annealing in a hood-type furnace under ambient atmosphere at 180° C., 9 h
Drawing to d=0.25 mm and stress-relief annealing

The relative cutting performances achieved with each wire electrode in the case of a spark-erosion machining in the main cut and in the case of a machining with a main cut and 3 trim cuts are indicated in Table 1. The spark-erosion machining was effected on a commercially available wire-eroding system with deionized water as dielectric. A 60-mm tall workpiece of hardened cold-worked steel of the X155CrVMo12-1 type was machined. A square with an edge length of 10 mm was chosen as cutting contour. A technology present on the machine side for bare brass wires with the composition CuZn40 was chosen as machining technology.

TABLE 1

| | | | Relative cutting |
|---|---|---|---|
| | | Relative cutting | performance over the |
| | Diameter | performance in | main cut and 3 trim |
| Wire sample | (mm) | the main cut (%) | cuts (%) |
| Comparison | 0.25 | 100 | 100 |
| sample V1 | | | |
| Comparison | 0.25 | 101 | 104 |
| sample V2 | | | |
| Comparison | 0.25 | 105 | 103 |
| sample V3 | | | |
| Sample E1 | 0.25 | 105 | 111 |
| according | | | |
| to the | | | |
| invention | | | |
| Sample E2 | 0.25 | 105 | 112 |
| according | | | |
| to the | | | |
| invention | | | |

The cutting performance achieved with comparison sample V1 in the main cut and, respectively, in the main cut and 3 trim cuts was set to 100% in each case.

Comparison sample V2 has a covering layer which consists of block-like particles. These particles have a zinc content of 60-63 wt.-% and consist predominantly of γ brass. The degree of coverage is approx. 35%. In a view perpendicular to the wire surface, the block-like particles the surface area of which lies in each case in the range of 25-250 μm² yield a total proportion of approx. 45% of the surface area of all block-like particles (see FIG. 7). In the case of this comparison sample, the thickness in the case of more than two thirds of the block-like particles, measured in the radial direction on a wire cross section, in the case of the final diameter, lies below 0.8% of the final diameter. Compared with comparison sample V1 the cutting performance is increased by 1% and 4% respectively.

Comparison sample V3 likewise has a covering layer which consists of block-like particles. These particles have a zinc content of 60-63 wt.-% and consist predominantly of γ brass. The degree of coverage is approx. 60%. In a view perpendicular to the wire surface, the block-like particles the surface area of which lies in each case in the range of 25-250 μm² yield a total proportion of less than 45% of the surface area of all block-like particles (see FIG. 8). Block-like particles with a surface area of more than 250 μm² and with a thickness, measured in the radial direction on a wire cross section, of more than 2% of the final diameter are increasingly present. In addition, the thickness of the block-like particles varies more strongly. With this comparison sample, the cutting performance is increased compared with comparison sample V1 by 5% and 3% respectively.

The sample E1 according to the invention has a covering layer which consists of block-like particles. The block-like particles are spatially separated, at least over a portion of their circumference, from each other or from the material of the wire core by cracks and indentations (gaps). The block-like particles have a zinc content of 60-63 wt.-% and consist predominantly of γ brass. The degree of coverage is approx. 40%. In a view perpendicular to the wire surface, the block-like particles the surface area of which lies in each case in the range of 25-250 μm² yield a total proportion of approx. 90% of the surface area of all block-like particles. In a view perpendicular to the wire surface, the block-like particles are arranged predominantly in line-shaped clusters of four or more particles. In these clusters the spacing between the particles is less than 15 μm. More than 50% of the line-shaped clusters form an angle with the longitudinal axis of the wire electrode of less than 40°. In the case of 80% of the block-like particles, the thickness, measured in the radial direction on a wire cross section, lies in the range of 3-4.5 μm, i.e. at 1.2-1.8% of the wire diameter. With the sample E1 according to the invention, the cutting performance is increased compared with comparison sample 1 by 5% and 11% respectively.

The sample E2 according to the invention has a covering layer which consists of block-like particles. The block-like particles are spatially separated, at least over a portion of their circumference, from each other or from the material of the wire core by cracks and indentations (gaps). The block-like particles have a zinc content of 60-64 wt.-% and consist predominantly of γ brass. The degree of coverage is approx. 45%. In a view perpendicular to the wire surface, the block-like particles the surface area of which lies in each case in the range of 25-250 μm² yield a total proportion of approx. 85% of the surface area of all block-like particles. In a view perpendicular to the wire surface, the block-like particles are arranged predominantly in line-shaped clusters of four or more particles. In these clusters the spacing between the particles is less than 15 μm. More than 50% of the line-shaped clusters form an angle with the longitudinal axis of the wire electrode of less than 40°. In the case of 80% of the block-like particles, the thickness, measured in the radial direction on a wire cross section, lies in the range of 3.5-4.5 μm, i.e. at 1.2-1.8% of the wire diameter. With the sample E1 according to the invention, the cutting performance is increased compared with comparison sample 1 by 5% and 12% respectively.

To assess the suitability for fine finishing, a spark-erosion machining with a main cut and 7 trim cuts was carried out with the comparison samples V1 and V3 and the samples E1 and E2 according to the invention. The spark-erosion machining was effected on a wire-eroding system customary in the trade with deionized water as dielectric. A 50-mm tall workpiece of cured cold-worked steel of the X155CrVMo12-1 type was machined. A square with an edge length of 10 mm was chosen as cutting contour. A technology present on the machine side for zinc-coated brass wires was chosen as machining technology. The target value for the arithmetical mean deviation of the roughness profile Rₐ is 0.13 μm. The measurement of the roughness on the eroded stamp-shaped component was effected by means of a stylus instrument. The measurement direction ran perpendicular to the wire run-off direction. The assessment of the groove formation was effected purely qualitatively with the naked eye. The measurement of the contour deviation was effected by means of a micrometer screw gauge in 2 axes and 3 different heights on the component (top, middle, bottom). The results are represented in Table 2.

An Rₐ value of 0.19 μm is achieved with comparison sample V1. The visual assessment of the component shows a strong formation of grooves. This result can generally be accounted for by the absence of a zinc-containing coating. An Rₐ value of 0.23 μm is achieved with comparison sample V3. The visual assessment of the component likewise shows a strong formation of grooves. The contour deviation is 5 μm. This result can be accounted for by the presence of block-like particles which have a larger thickness compared with the samples E1 and E2, as well as by the more strongly varying thickness of the block-like particles.

With the samples E1 and E2 according to the invention, a surface roughness, with an Rₐ value of 0.13 μm, which only marginally deviates from the target value is achieved. The formation of grooves is small. The contour deviation in both cases is 3 μm, and thus lies at the level of comparison sample V1.

TABLE 2

| | | | Groove | |
|---|---|---|---|---|
| | | Surface | formation | |
| | | roughness | (Visual assessment) | |
| | | on the | 1 = small | Contour |
| | Diameter | workpiece | 2 = moderate | deviation |
| Wire sample | (mm) | in Rₐ (μm) | 3 = strong | (μm) |
| Comparison | 0.25 | 0.19 | 3 | 3 |
| sample V1 | | | | |
| Comparison | 0.25 | 0.23 | 3 | 5 |
| sample V3 | | | | |
| Sample E1 | 0.25 | 0.13 | 1 | 3 |
| according | | | | |
| to the | | | | |
| invention | | | | |
| Sample E2 | 0.25 | 0.13 | 1 | 2 |
| according | | | | |
| to the | | | | |
| invention | | | | |

### REFERENCE NUMBERS

1: wire electrode

2: wire core

3: block-like particles

4: cracks surrounding the block-like particles

4′: cracks inside the block-like particles

5: centre axis (longitudinal axis) of the wire electrode

6: reference frame

7: line-shaped clusters of block-like particles

### CITED DOCUMENTS

U.S. Pat. No. 5,945,010

U.S. Pat. No. 6,306,523

U.S. Pat. No. 7,723,635

EP-A-2 193 867

EP-A-1 846 189

EP-A-2 517 817

EP-A-1 295 664

EP-A-1 949 995

1. A wire electrode for spark-erosion cutting having
a core, which contains a metal or a metal alloy, and
a covering layer, surrounding the core, which comprises regions the morphology of which corresponds to block-like particles, which are spatially separated, at least over a portion of their circumference, from each other and/or the core material by cracks, characterized in that, viewed in a wire cross section perpendicular or parallel to the wire longitudinal axis, the portion amounting to more than 50% of the surface area of a region with the morphology of a block-like particle contains a copper-zinc alloy with a zinc concentration of 58.5-67 wt.-%, wherein, in a view perpendicular to the wire surface, the proportion of the surface formed by the block-like particles is more than 20% and less than 50% of the entire surface of the wire electrode and the block-like particles the surface area of which in each case lies in the range of 25-250 μm² in total make up a proportion of more than 50% of the surface area of all block-like particles.

2. The wire electrode according to claim 1, in which the portion amounting to more than 75% of the surface area of the block-like particles contains a copper-zinc alloy with a zinc concentration of 58.5-67 wt.-%.

3. The wire electrode according to claim 1, in which the proportion of the surface formed by the block-like particles is more than 30% and less than 45% of the entire surface of the wire electrode.

4. The wire electrode according to claim 1, in which, in a view perpendicular to the wire surface, the block-like particles the surface area of which lies in the range of 25-200 μm² in total make up a proportion of more than 50% of the surface area of all block-like particles.

5. The wire electrode according to claim 1, in which the block-like particles are present in line-shaped clusters of four or more particles, within which the spacing between two particles is less than 15 μm.

6. The wire electrode according to claim 5, in which the spacing between two particles within the line-shaped clusters is less than 10 μm.

7. The wire electrode according to claim 5, in which the majority of the line-shaped clusters form an angle with the longitudinal axis of the wire electrode of less than 45°.

8. The wire electrode according to claim 5, in which the majority of the line-shaped clusters form an angle with the longitudinal axis of the wire electrode of less than 40°.

9. The wire electrode according to claim 1, in which, viewed in a wire cross section perpendicular or parallel to the wire longitudinal axis, more than two thirds of the block-like particles have a thickness, measured in the radial direction, of more than 0.8% and less than 2% of the total diameter of the wire electrode.

10. The wire electrode according to claim 9, in which more than 75% of the block-like particles have a thickness, measured in the radial direction, of more than 0.8% and less than 2% of the total diameter of the wire electrode.

11. The wire electrode according to claim 1, in which the metal is copper and the metal alloy is a copper-zinc alloy.

12. The wire electrode according to claim 1, in which the core is formed of copper or a copper-zinc alloy with a zinc content of from 20 to 40 wt.-%.

13. The wire electrode according to claim 1, in which the core is formed of one of the alloys CuZn₃₇ or CuZn₄₀.

14. The wire electrode according to claim 1, in which the regions with the morphology of block-like particles have inner cracks.
